(19) United States
(12) Patent Application Publication
(10) Pub. No.: US 2025/0316010 A1
(43) Pub. Date: Oct. 9, 2025

(54) VIDEO GENERATION FOR SHORT-FORM CONTENT

(71) Applicant: Lemon Inc., Grand Cayman (KY)

(72) Inventors: Roland Geisler, Los Angeles, CA (US); Weiguo Feng, Los Angeles, CA (US); Bingyue Peng, Los Angeles, CA (US); Jiandong Yang, Los Angeles, CA (US); Junfu Chen, Los Angeles, CA (US); Patrick Courtney, Los Angeles, CA (US)

(21) Appl. No.: 18/914,672

(22) Filed: Oct. 14, 2024

Related U.S. Application Data
(60) Provisional application No. 63/575,067, filed on Apr. 5, 2024.
(60) Provisional application No. 63/650,062, filed on May 21, 2024.
(60) Provisional application No. 63/658,247, filed on Jun. 10, 2024.

(51) Int. Cl. G06T 13/40; G06F 40/40; G06Q 30/0251; G06T 11/00; G06T 13/80

(52) U.S. Cl. CPC G06T 13/40; G06F 40/40; G06Q 30/0269; G06T 11/00; G06T 13/80; G06T 2200/24

(57) ABSTRACT

Methods, systems, and apparatus, including computer programs encoded on computer storage media, for content generation are provided. One of the methods includes receiving one or more user input identifying information associated with one or more media elements and one or more characteristics of the video to be generated; and generating video content based on the received one or more user inputs, the generating comprising: identifying assets to include in the video, the assets including an avatar, generating a script for the video, and assembling a video layout.

### CROSS-REFERENCE TO RELATED APPLICATIONS

This application claims the benefit under 35 U.S.C. § 119(e) of the filing date of U.S. Provisional Patent Application 63/575,067, which was filed on Apr. 5, 2024, U.S. Provisional Patent Application 63/650,062, which was filed on May 21, 2024, and U.S. Provisional Patent Application 63/658,247, which was field on Jun. 10, 2024. The disclosure of the foregoing applications are incorporated here by reference.

### BACKGROUND

This specification relates generally to generating video content. Some online social media platforms, or other content sharing platforms, allow content providers to upload video content for distribution to one or more other users of the platform. For example, a user can create a short-form video having particular content. The user can upload the short-form video to the platform. The platform can select the short-form content to provide in a video feed of one or more other users of the platform.

### SUMMARY

This specification describes technologies for generating short-form video content, e.g., particular video files having specifically generated content. In particular, video content can be automatically generated in response to particular user input including one or more elements and one or more content parameters. The generated video content can form the basis of a sponsored content item that can be used by an online social media or other content sharing platform (the “platform”). The platform can provide the sponsored content item to individual user devices associated with accounts on the platform for presentation, for example, as part of individual user video feeds.

In particular, video content can be automatically generated with only initial inputs from a creator user. In some implementations, a user may provide additional input to refine the video content generation process. In response to the initial user input, the video generation system can identify available assets including appropriate on-screen talent, generate a script, assemble a sequence of assets, and decorate the video content with speech corresponding to the script, music, and other content.

In general, one innovative aspect of the subject matter described in this specification can be embodied in methods that include the actions of receiving one or more user input identifying information associated with one or more media elements and one or more characteristics of the video to be generated; and generating video content based on the received one or more user inputs, the generating comprising: identifying assets to include in the video, the assets including an avatar, generating a script for the video, and assembling a video layout. Other embodiments of this aspect include corresponding computer systems, apparatus, and computer programs recorded on one or more computer storage devices, each configured to perform the actions of the methods.

In general, another innovative aspect of the subject matter described in this specification can be embodied in methods that include receiving one or more user inputs identifying information associated with one or more media elements and one or more characteristics, the one or more media elements including one or more videos; and generating a remixed video content based on the received one or more user inputs, wherein generating the remixed video content comprises: separating the one or more videos into respective clips; generating a script; and assembling a video layout from one or more of the clips. Other embodiments of this aspect include corresponding computer systems, apparatus, and computer programs recorded on one or more computer storage devices, each configured to perform the actions of the methods.

This specification uses the term “configured” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

The subject matter described in this specification can be implemented in particular embodiments so as to realize one or more of the following advantages. Short-form video creation can occur 10-100 times faster than developing the video content manually. Conventional short-form video production costs can be significant, while the described machine learning approach can create a video for a negligible cost per video, e.g., less than 10 cents each. The system for video generation provides a convenient technique that almost anyone can use within specialized creative or technical skills

Video content can be generated using on-screen talents with minimum context provided by a creator user as input. By contrast, traditional techniques for generating particular video content, for example showcasing a particular product, can be costly and time consuming processes that can require both creative skill and technical knowledge on the part of the creator. Using the techniques described in this specification users can create high quality short-form video content with minimal effort and low cost without the need for any specialized training. In particular, in some implementations, the video generation uses generative artificial intelligence, for example based on one or more large language models, trained to generate video content having particular characteristics and based on particular inputs, as described in greater detail below. This results in a video generation process that is significantly faster, e.g., may take less than a minute to generate, and more efficient than traditional techniques.

Further innovative aspects include the ability to automatically generate short-form video content tailored to characteristics of the platform so that the short-form video content is more likely to perform well on the platform, e.g., “trendy” content. Users are able to provide the input information to a content generation system quickly, e.g., in some cases less than a minute, from which the system can generate a video much more quickly than through conventional manual creation.

Using the techniques described in this specification users can create a new and fresh remixed version of one or more prior videos with minimal effort and low cost without the need for any specialized training. In particular, in some implementations, the video generation uses generative artificial intelligence, for example based on one or more large language models, trained to generate and/or arrange video content having particular characteristics and based on particular inputs, as described in greater detail below. This results in a video generation process that is significantly faster, e.g., may take less than a minute to generate, and more efficient than traditional techniques.

Conventional video creation is typically a time-consuming and costly activity that can require both creative skill and technical knowledge on the part of the creator. Using the techniques described in this specification users can create high quality short-form video content with minimal effort and low cost without the need for any specialized training. In particular, in some implementations, the video generation uses generative artificial intelligence, for example based on a large language model, trained to generate video content having particular characteristics and based on particular inputs, as described in greater detail below.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for creating and distributing generated video content.

FIG. 2 is a block diagram illustrating an example content generation system for generating video content.

FIG. 3 illustrates an example format of a video.

FIG. 4 is a flow diagram of an example process for generating content.

FIG. 5 illustrates a user interface in which a user can view and/or select a particular avatar as part of their initial input.

FIG. 6 illustrates an example user interface in which the creator user can provide input of a style of the video to be generated.

FIGS. 7A-B illustrates two images representing frames of generated video content representing different avatars, styles, etc.

FIG. 8 is a block diagram illustrating another example content generation system for generating video content.

FIG. 9 is a flow diagram of an example process for remix content generation.

FIG. 10 illustrates an example user interface in which a number of videos have been generated.

FIG. 11 shows an example user interface of additional settings that the creator user can specify to further refine the generated video content.

FIG. 12 shows an example user interface in which a creator user can provide information about the product.

FIG. 13 shows an example user interface in which the user uploaded videos are previewed.

FIG. 14 illustrates some functions of a clip generator.

FIG. 15 shows an example user interface for video content generation.

FIG. 16 shows another example user interface for video content generation.

FIG. 17 shows an example user interface for receiving the additional user preferences.

FIG. 18 shows an example user interface illustrating an output presentation of generated videos.

FIGS. 19A-C shows three separate example representations of portions of an output video generated by the system.

FIG. 20 shows an example user interface for editing a generated video.

FIG. 21 is a block diagram of a schematic diagram of an example computing system Like reference numbers and designations in the various drawings indicate like elements.

### DETAILED DESCRIPTION

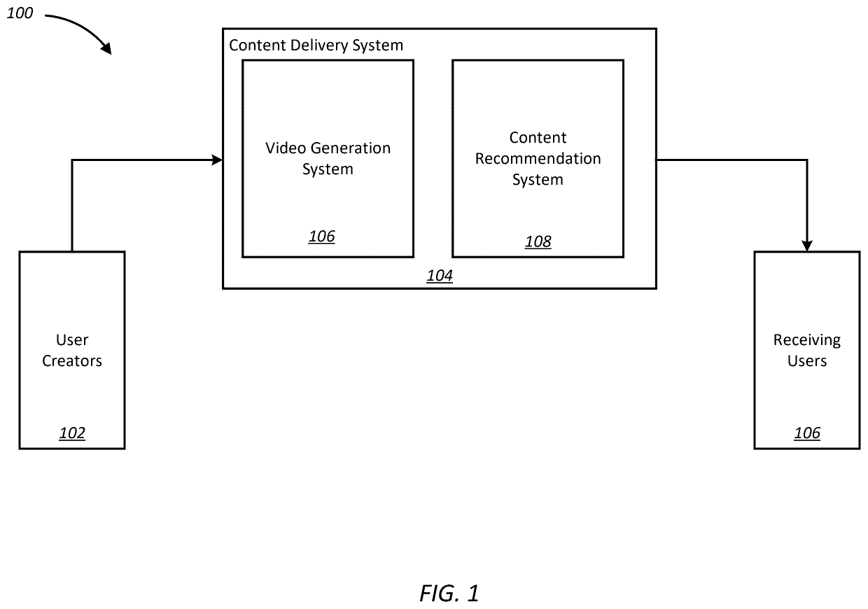

FIG. 1 is a block diagram of an example system 100 for creating and distributing generated video content. The system 100 includes user creators 102, content delivery system 104, and receiving users 106. The content delivery system 104 can be part of, for example, a social media platform.

User creators 102 interact with the content delivery system 104 using one or more user devices. The user device can communicate with the content delivery system 104 as part of a video generation process. The user devices can be any Internet-connected computing device, e.g., a laptop or desktop computer, a smartphone, or an electronic tablet. The user device can be connected to the Internet through a mobile network, through an Internet service provider (ISP), or otherwise.

Each user device is configured with software, which will be referred to as a client or as client software, that in operation can access the content delivery system 104 so that a user can interact with the content delivery system 104. For example, the client software can provide a user interface for receiving user input for generating video content. The user interface can also present one or more resulting videos, for example, for user approval.

The content delivery system 104 can include multiple systems or modules used to provide various content to receiving users 106. For example, the content delivery system 104 can be part of a platform in which video content is provided to receiving users, e.g., having corresponding user accounts on the platform. The video content can be short form videos. Short form videos are videos that are typically less than 90 seconds in length. In some implementations, short form videos have lengths of between 15 and 90 seconds. By contrast, long-form videos typically have lengths of at least 3 minutes.

For example, the receiving users 106 can include client software. The client software provides a user interface for interacting with the platform 104. The user interface can include receiving data from the platform 104 for presenting a feed of videos that the user can interact with. For example, the user can scroll up or down to switch between videos in the feed as well as interact with individual videos, e.g., by posting comments about the video, sharing the video, or expressing approval, e.g., liking the video.

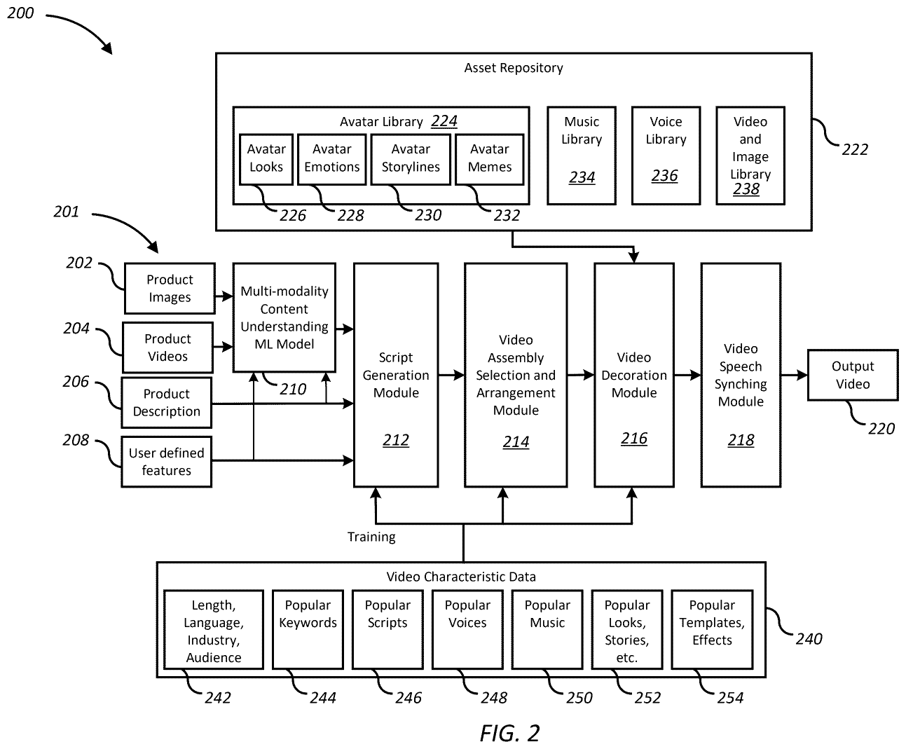

In particular, within the context of a video generation, the content delivery system 104 can include a video generation system 108 and a content recommendation system 110. The video generation system 108 generates short form video content in response to particular user input or prompts. For example, the user can provide identifying information for a particular product, a price, and a description. From this input, the video generation system 108 can generate a short form video for the product. The video generation is described in greater detail with respect to FIG. 2.

The content recommendation system 110 identifies particular content to provide to the devices of the receiving users 106. For example, the content recommendation system 110 can use a particular model that predicts content likely to be of interest to individual users, for example, based on their past behavior and viewing history. The content recommendation system 110 system can be, for example, a machine learning model that predicts items likely to be of interest to the user based, for example, on historical activities of the user as well as the trained model parameters.

FIG. 2 illustrates a content generation system 200 for generating video content. A set of inputs 201 are provided to the system 200. For example, a user can interact with a user interface displayed on a user device to directly or referentially provide inputs. The inputs 201 include product images 202, product videos 204, product description 206, and user defined characteristics 208.

The product images 202 and product videos 204 can be directly provided by the user by uploading files from their user device to the system 200. Alternatively, the user can provide a reference to a location that includes image or video content. For example, the user can provide a URL address that points to a product page, for example, on a retail webpage. The system 200 can obtain image and/or video content from the location identified in the URL.

The product description 206 can be provided by the user, e.g., as text input into a text box of the user interface. The description can also be pulled from the location referenced by the URL, e.g., a product description on the retail webpage. The description can also include a sales price for the product.

The user defined characteristics 208 can include features identified by the user for the generated video content. For example, a length of the video, e.g., 15 seconds, 30 seconds, a language, e.g., English, a target audience, e.g., an age range, gender, or geographic location, an industry, e.g., health, automotive, gaming.

The inputs 201 are obtained, whether directly from the user, or from the user identified location, by the system. The image and video inputs can be provided to a multi-modality content understanding machine learning model 210.

The multi-modality content understanding machine learning model 210 employs tagging and classification models to understand the subject of the video to be generated, e.g., based on a product from the obtained product images and/or video input. In some implementations, a multimodal model such as Contrastive Learning In Pretraining (CLIP) for Embedding model which can be trained using both text and images. As such it can further classify input images and identify semantic text that corresponds to the image. In some other implementations, different classification models can be used to provide an understanding to the system of the product.

The multi-modality content understanding machine learning model 210 can further identify one or more avatar assets that are compatible with the product. Based on a classification of the product or other input data a particular avatar may be more suitable. For example, if the product is a video game, perhaps product videos are more likely to be presented by male avatars that are under 30 years old. By contrast, a golf club might be more likely to be presented by a male avatar that is between 50 and 60 years old. Based on different avatars 226 in an avatar library 224, an avatar can be selected that matches the classification of the product according, for example, to a threshold probability. Additionally, one or more of the user defined features 208 can be used in determining a suitable avatar. For example, the target audience identified by the creator user may be relevant in selecting the best avatar, e.g., one having a probability of target user engagement with the video that satisfies a particular threshold value.

The avatar corresponds to a digital representation of a real life model. Each avatar can include a number of different poses, e.g., sitting, standing, etc., emotions 228, presentation styles, e.g., storylines, and memes. Avatars are described in more detail below.

Based on the input content and the identified avatar or avatars, the system generates a script for the video using a script generation module 212. The script describes an overall story for the video content being generated. For example, for a particular product, the script indicates not only the words to be used, but also establishes a particular style targeted, for example, toward the specified audience. Furthermore, the script is associated with some individual or partial pieces of media (i.e., video or image) content, e.g., representing the product, identified by the user.

The script can be generated using a large language model (LLM) that can be a generative model (e.g., artificial intelligence model). The model can be trained to evaluate both text and image input in developing a script for the video. For example, if the video content is a product review for a particular brand of olive oil, the script generation used the images, the description, the user defined characteristics, and the available avatar assets in determining the script.

Furthermore, the model can be trained on a particular corpus of content in line with a particular style. For example, for a video being generated for delivery on a video sharing social media platform having a particular style of short form video content, the model can be trained on content from the platform so that the script generated has a style, content, cadence, etc. that is consistent with content on the platform. The content information can further include performance information, e.g., signals indicating how the video content trended and with particular audiences. Characteristics of platform videos are described in greater detail below with respect to model training.

Next, the inputs are provided to a video assembly selection and arrangement module 214. In particular, given a particular script and set of assets including the avatar and image content, for example, product images, the video assembly selection and arrangement module 214 determines an ordered sequence of scenes to compose the overall video. For example, the assembly can be based on matching semantic representations (i.e., Embeddings) of the script content and user-input asset semantic representation (i.e., Embedding) to determine suitable shot sequences for each script segment.

For example, if the script begins with an unboxing concept, e.g., the unboxing to reveal the product from particular packaging, and there is corresponding avatar video, the scene can align with the video content and script portion.

Video content may have a particular schema defining distinct scenes of the video. For example, an initial portion may be designed to hook the viewer so that they stay on the video vs. scroll to a next video, A second portion may be the body of the product description or review, and a third portion may be a call to action, e.g., a description of how or where to obtain the product. Different avatar assets and scenes may be tied to each of these portions. For example, the hook portion may be facilitated by an avatar expressing a particular emotional reaction, e.g., excitement. For example, the avatar library 224 can include avatar emotion assets 228 that represent different emotional responses of the model, Thus, the avatar behavior, look, pose, etc. can vary for different scenes within the video.

The video assembly can also include background images or video. The images can be obtained from a video and image library 238 of the asset repository 222. Thus, images can be selected from a repository of stock images. The images can be selected by the multi-modality content understanding model 210 based on the input characteristics and classifications. For example, if the product is a brand of coconut water, images or video of tropical beach settings can be used in the background. In another example, if the target audience is located in a particular city, images related to that city can be obtained. In a further example, the time of year or relationship to particular holidays may be used, e.g., for a video generated in December, Christmas images may be included. Different images or videos can be selected for different scenes of the video based, for example, on the script in order to provide a more dynamic video.

Once the structure and organization of the video is complete, the video decoration module 216 adds additional details to the video including selecting a voice for the script, and music for the video.

The video decoration module 216 can include a text-to-speech model that generates speech corresponding to the script. Additionally, a particular voice can be selected, e.g., from a voice library 236 of the asset repository 222. For example, voices can be for different languages, different dialects, or different pitches.

Music can be added to complement the video content. The music can be background music or it can be music to complement the script, for example, introductory music before the first speech. The music can be identified based on the input images/video and the script through multimodal matching models. The music can be selected from a music library 234 in the asset repository 222.

In some implementations, the video decoration module 216 also generates subtitles that can be rendered during the video. The subtitles are based on a segmentation of the script to correspond to the speech components. For example, the segmentation and phrasing of the script can be performed based on natural language processing models including LLM or other generative models.

The video is further processed by video speech synching module 218. The video speech synching model 218 aligns the voice components with facial movements of the avatar when visible in the video. Thus, the avatar is presented as speaking the words of the generated script.

The final video is then output 220. The video can be presented to the creator user for approval or modification. In some instances, the video generation process described above is carried out multiple times to create a set of video options for the creator user to select from. Once approved, the generated video can be loaded to the content delivery system such that the video is available for selection, e.g., by a content recommendation system, to provide to particular receiving users. For example, the content delivery system can include a recommendation system that determines content to provide to user devices in response to a request for content. In particular sponsored content items, e.g., advertisements, can be selected for presentation to users by the content delivery system, for example, by inserting the sponsored content video into a video feed determined for a particular user.

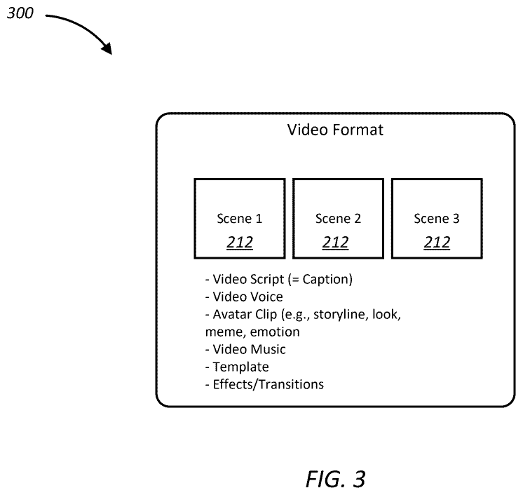

FIG. 3 illustrates an example format of a video 300. The video 300 includes a sequence of scenes 302, 304, and 306. Each scene can be associated with a portion of the script and other corresponding assets and elements including a particular voice, avatar portion, music, and effects or transitions.

The training of the models used to generate the script, assemble the video, and video decoration can be based on video characteristic data 240. The video characteristic data includes particular data associated with other content that the video should emulate, e.g., other short form video content on the social media platform. In some implementations, the video content is specifically sponsored content videos, but in other implementations, the content can be more broadly encompassing videos on the platform. For example, new trends may originate organically from user supplied content, which can then inform the video generation process to generate videos on trend and representative of native platform content.

The video characteristic data 240 can include video characteristics 242 such as length, language, industry segment, and audience associated, for example with other generated videos along with data on whether users viewed or interacted with the videos.

The video characteristic data 240 can include popular keywords 244. These represent keywords from video content on the social media platform that is popular, meaning the videos with these keywords have signals indicating a positive response by viewers. In some implementations, the keywords relate to other product videos. Signals indicating a positive response can include a viewing time and viewer interactions (e.g., liking the video or commenting on the video).

The video characteristic data 240 can include popular scripts 246. Popular scripts can represent particular text styles or patterns from video content on the social media platform that is popular, meaning particular script content that includes signals indicating a positive response by viewers.

The video characteristic data 240 can include popular voices 248. As described above, the avatar speaks with a particular selected voice. This not only includes male/female but can include age, regional dialect, accents, language, etc. Similar to the above, popular voices relate to voice content in video that includes signals indicating a positive response by viewers of the video content.

The video characteristic data 240 can include popular music 250. Music is often trend dependent. What is popular today may be less popular tomorrow or next month. To keep the content of the generated video having a sense of being current, music, whether by specific artists or just reflecting particular genres or styles, that is currently popular can be preferred. The music can also be based on the target audience, e.g., music popular with the target audience vs. popular generally.

The video characteristic data 240 can include popular looks, stories, and the like 252. As described above, avatars are digital versions of real world models who are digitally captured doing a number of different activities and poses. Some of these may have a more positive response than others by viewers, and in particular by viewers matching the target audience of the video being generated.

The video characteristic data 240 can include popular templates or effects 254. The templates or effects can refer to different transitions between scenes, or different structures to the video storyline. Effects can include, for example, filters (audio and/or video), transitions, augmented reality effects, overlays, or inserted objects. As above, popularity relates to signals indicating a positive viewer response.

The models can be updated periodically based on updated video characteristic data 240. Each generated video is basically a combination of elements (videos, image, voice, music, avatar, script, scenes, industry, audience, etc.), and the performance scores of the videos on the social media platform can be used as labeled cases to continuously train the various models.

Referring back to the potential assets in the avatar library 224, each avatar can include a number of different poses 226, e.g., sitting, standing, etc., emotions 228, presentation styles 230, e.g., storylines, and memes 232.

As described above the avatar looks 226 and avatar emotions 228 refer to different captures of the real life model, for example, seated vs. standing or expressing excitement, delight, or disbelief emotions.

The avatar presentation styles 230 relate to particular avatar storyline. For example, the storyline may be the unboxing of a product. Alternatively, the storyline may relate to the presentation and use of the product. The avatar storylines can include model captures relating to performing different activities that relate to particular activities that can form a storyline for the video. For example, an unboxing storyline may include video clips of the avatar carrying a box, placing the box on a table, opening the box, etc.

The avatar memes 232 relate to trending expressions or gestures that have become popular on the social media system and can be used to enhance the video content. For example, one meme might be a person forming a “heart” symbol with their hands. Other example memes can represent particular scenes, a certain voice/audio style, etc., attached to a certain person and what they said. Other creators perform the meme in their own way on their own generated content such that the viewing audience recognizes the meme being performed. Thus, a variety of new memes can be generated regularly on a given social media platform. The model can be captured performing the meme, which can then be available for inclusion in generated video content.

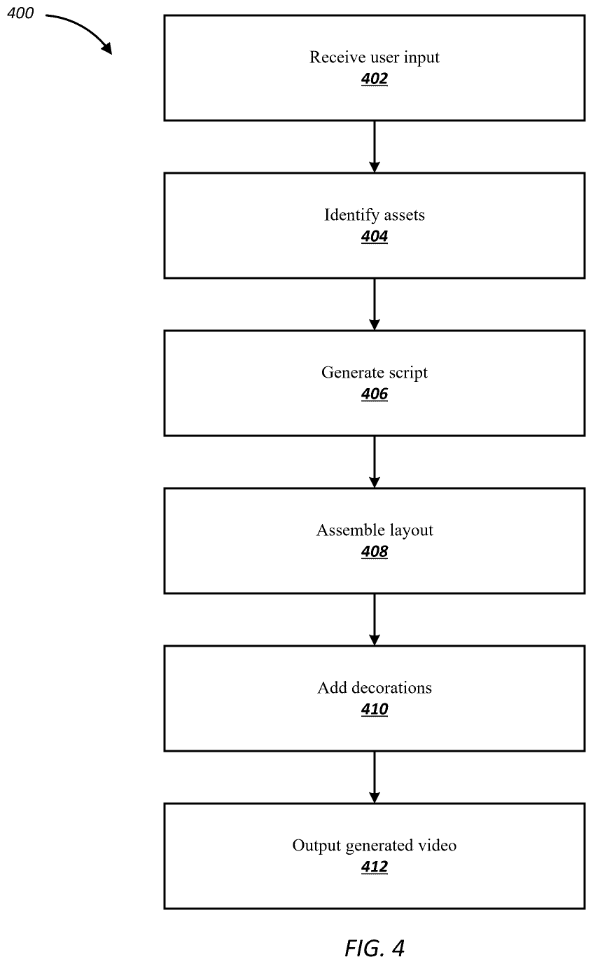

FIG. 4 is a flow diagram of an example process 400 for generating content. For convenience, the process 400 will be described as being performed by a system of one or more computers, located in one or more locations, and programmed appropriately in accordance with this specification. For example, a content generation system, e.g., the content generation system 200 of FIG. 2, appropriately programmed, can perform the process 400.

The system receives user input (402). The user input can be associated with a particular item. The item can be, for example, a product or service. The user input can include information associated with one or more media elements. The media elements can include one or more of images or videos, e.g., representative of the item. The user input can also include a written description of the product which can be originated by the user or provided by reference, e.g., to a URL address that includes a description of the item.

The system identifies one or more assets (404). Identifying one or more assets can include identifying a particular avatar to use in generating video content. The avatar can be identified in response to additional user input, e.g., providing particular parameters or styles associated with the video content to be generated. In some alternative implementations, the avatar is selected by the system, for example, based on information collected about the item.

The system generates a script (406). The script describes an overall story for the video content being generated. As described above, the script can be automatically generated using a generative model based on an LLM.

The system assembles a video layout (408). Assembling the video layout includes defining a sequence of scenes. Each scene can include a particular avatar configuration and script segment.

The system optionally adds video decorations (410). The video decoration can include determining a particular voice to use in reading the script as well as music to add to the overall generated video.

The system outputs one or more generated videos (412). For example, the system may run the preceding process steps one or more additional times to form a new generative result from the model. The user can be presented with a preview interface that includes information about each generated video. Furthermore, the system can provide additional information to aid the user in evaluating the different generated videos including scoring the videos based on the various scoring metrics.

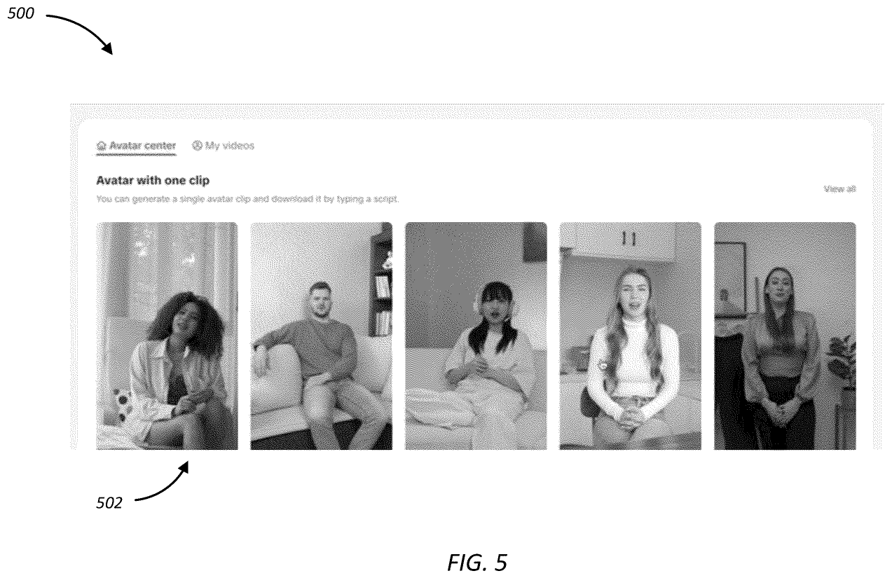

In some instances, the user input can include a selection of the avatar from a collection of avatar options. FIG. 5 illustrates a user interface 500 in which a user can view and/or select a particular avatar 502 as part of their initial input. Thus, rather than having the system select an avatar, the creator user can specify the avatar to use. The avatars can have different poses and environments. The background can be used, or replaced by a different asset.

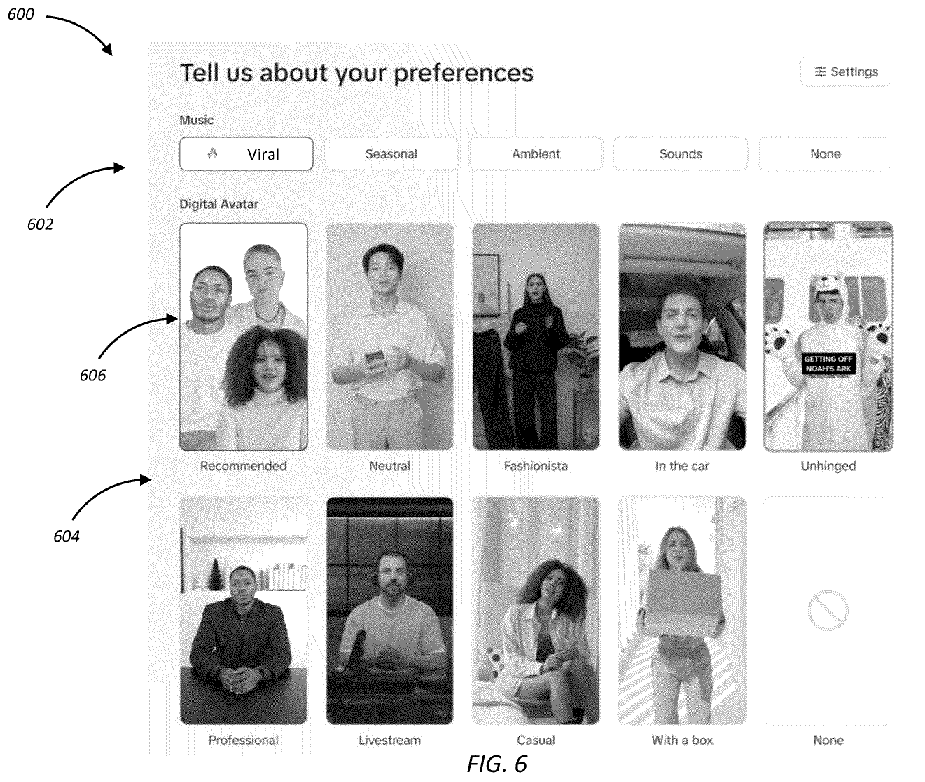

In some implementations, the user input can include a selection of a style for the video to be generated. FIG. 6 illustrates an example user interface 600 in which the creator user can provide input of a style of the video to be generated, There can be a set of categories 602 from which the user can select, e.g., trending styles, seasonal styles, etc. An array of images 604 representing different styles can be presented for the selected category, e.g., a user recording in the car vs. a casual home environment. Additionally, the user can select a “recommended” style 606 so that the style is chosen by the system during the video generation process.

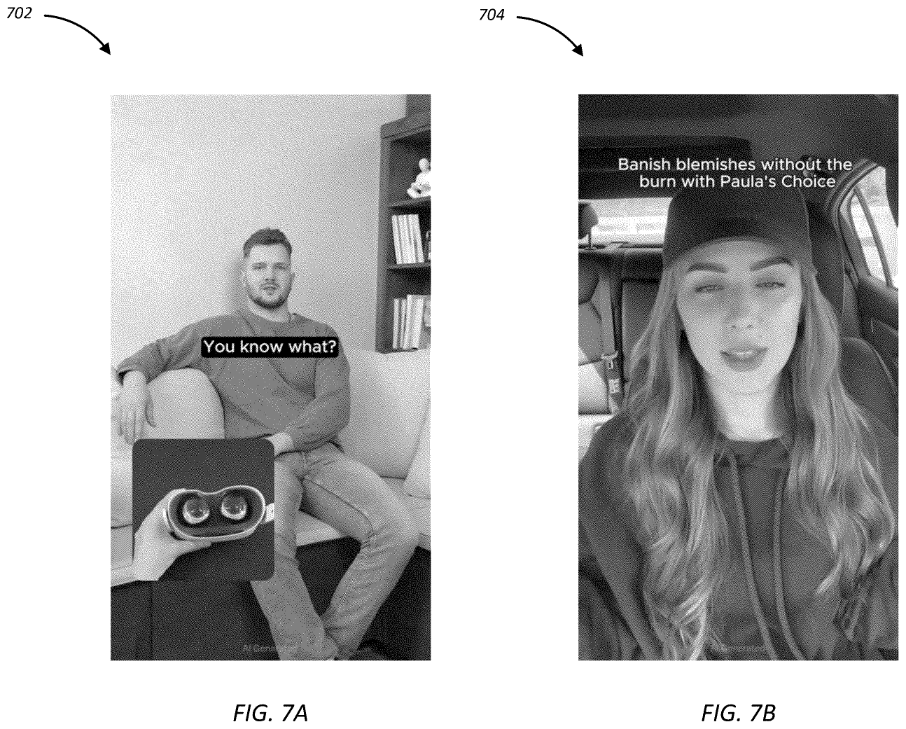

The final videos can be presented to the creator user to preview as well as to receiving users. FIGS. 7A-7B illustrates two images representing frames of generated video content. Each frame represents content generated with different avatars, styles, etc. FIG. 7A shows frame 702 with an avatar sitting on a couch. FIG. 7B shows frame 704 with an avatar “recording” a video in a car.

As described above, the techniques described in this specification can be used to generate video content, and in particular short-form video content. The video generation system can be part of an online social media platform. The video content can be generated as a sponsored content item that can be provided to users of the platform, e.g., as advertising content that is selected by the platform to provide to users according to particular selection criteria. The sponsored content an be included within a stream of other individual short-form videos provided to a user device.

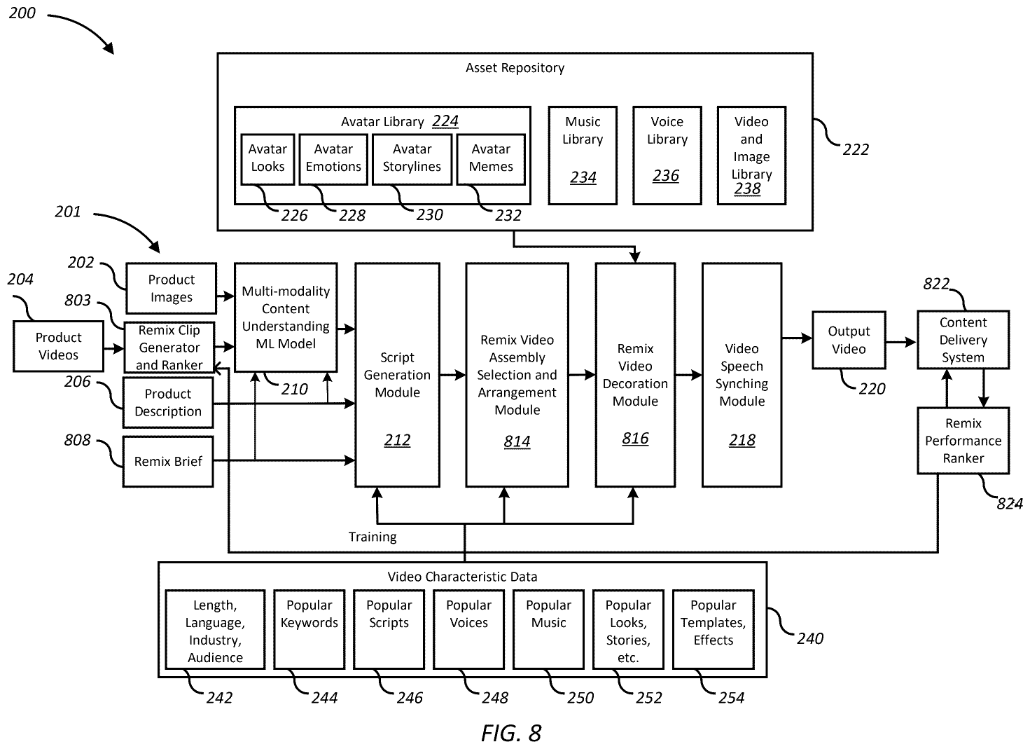

FIG. 8 illustrates another content generation system 800 for generating remixed video content. The content generation system 800 can be a system that is part of a content delivery system such as content delivery system 104 of FIG. 1. A set of inputs 201 are provided to the system 800. For example, a user can interact with a user interface displayed on a user device to directly or referentially provide inputs. The inputs 201 include product images 202, product videos 204, product description 206, and a remix brief 808.

The product images 202 and product videos 204 can be directly provided by the user by uploading files from their user device to the system 800. Alternatively, the user can provide a reference to a location that includes image or video content. For example, the user can provide a URL address that points to a product page, for example, on a retail webpage. The system 800 can obtain image and/or video content from the location identified in the URL. In particular, the user can identify or directly provide prior video content for the product. This prior video content can include previously created short-form videos e.g., created for delivery by the online social media platform to users of the platform.

The product description 206 can be provided by the user, e.g., as text input into a text box of the user interface. The description can also be pulled from the location referenced by the URL, e.g., a product description on the retail webpage. The description can also include a sales price for the product.

The remix brief 808 can include features identified by the user for the generated remixed video content. For example, a desired length of the video, e.g., 15 seconds, 30 seconds; a language, e.g., English; a target audience, e.g., an age range, gender, geographic location, or interests; and/or an industry, e.g., health, automotive, gaming. The remix brief 808 can include details for tailoring the remix video to particular events or locations. For example, the event may be a holiday such as Christmas or Valentine's Day. The location may be a particular country or city, for example. The remix brief 808 can also include information associated with a particular style desired for the video content, e.g., funny or fast-paced.

The inputs 201 are obtained, whether directly from the user, or from the user identified location, by the system. The product videos 204 can then be provided to a remix clip generator and ranker 803. The remix clip generator and ranker 803 takes the existing videos and separates each of them into a number of individual clips. For example, the remix clip generator can identify scene breaks in the videos as clip boundaries. Scene breaks can be identified from the video content, for example, based on a change in background, a change in the speaker location/pose, or a change in script content indicating a scene break. The clips can be further processed by a content understanding engine to understand the nature of the content in each clip, for example, is there a person present in the clip or is it a video of the product alone.

The clips are scored based on a number of different ranking criteria. The ranking criteria can include whether or not a person is present in the clip, the composition of the scene presented by the clip, the type of clip, clip content (e.g., images of the product, product in action, no product) among other criteria. Clips, and in particular similar clips from different videos, can further be evaluated based on performance data when available. For example, if the video was previously used as a content item on the platform, there may be performance metrics on the video captured by the platform, e.g., number of views, viewing user engagement with the video, etc. Another factor that can be used in ranking the clips is based on how the clips align with the provided information in the remix brief. For example, whether a given clip fits the target audience, industry segment, etc.

The images 202, description 206, and remix brief 808 can be provided to a multi-modality content understanding machine learning model 210. Additionally, the video clips of the product videos 204 can be provided to the multi-modality content understanding machine learning model 210 after processing by the remix clip generator and ranker 803.

The multi-modality content understanding machine learning model 210 employs tagging and classification models to understand the product from the obtained product images and/or video input. In some implementations, a multimodal model such as Contrastive Learning In Pretraining (CLIP) for Embedding model which can be trained using both text and images. As such it can further classify input images and identify semantic text that corresponds to the image. In some other implementations, different classification models can be used to provide an understanding to the system of the product.

In some implementations, remixing the video content includes generating one or more new scenes. The new scenes can employ an avatar asset used to provide automatically generated content. The multi-modality content understanding machine learning model 210 can identify one or more avatar assets that are compatible with the product. Based on a classification of the product or other input data a particular avatar may be more suitable. For example, if the product is a video game, perhaps product videos are more likely to be presented by male avatars that are under 30 years old. By contrast, a golf club might be more likely to be presented by a male avatar that is between 50 and 60 years old. Based on different avatars 226 in an avatar library 224, an avatar can be selected that matches the classification of the product. Additionally, one or more of the user defined features 208 can be used in determining a suitable avatar. For example, the target audience identified by the creator user may be relevant in selecting the avatar.

The avatar corresponds to a digital representation of a real life model. Each avatar can include a number of different poses, e.g., sitting, standing, etc., emotions 228, presentation styles, e.g., storylines, and memes. Avatars are described in more detail below.

Based on the input content, the generated and ranked clips, and optionally the identified avatar or avatars, the system generates a script for the video using a script generation module 212. The script describes an overall story for the video content being generated. For example, for a particular product, the script indicates not only the words to be used, but also establishes a particular style targeted, for example, toward the specified audience. Furthermore, the script is associated with some individual or partial pieces of media (i.e., video or image) content, e.g., representing the product, which can include one or more selected clips from the clip generator as well as newly acquired or generated assets.

The script can be generated using a large language model (LLM) that can be a generative model (e.g., artificial intelligence model). The model can be trained to evaluate both text and image input in developing a script for the video. For example, if the video content is a product review for a particular brand of olive oil, the script generation used the images, the description, the user defined characteristics, and the available avatar assets in determining the script.

Furthermore, the model can be trained on a particular corpus of content in line with a particular style. For example, for a video being generated for delivery on a video sharing social media platform having a particular style of short form video content, the model can be trained on content from the platform so that the script generated has a style, content, cadence, etc. that is consistent with content on the platform. The content information can further include performance information, e.g., signals indicating how the video content trended and with particular audiences. Characteristics of platform videos are described in greater detail below with respect to model training.

Next, the inputs are provided to a remix video assembly selection and arrangement module 814. In particular, given a particular script, the ranking scores of the clips, and set of assets including the avatar and image content, for example, product images, the video assembly selection and arrangement module 814 determines an ordered sequence of scenes to compose the overall video. For example, the assembly can be based on matching semantic representations (i.e., Embeddings) of the script content and user-input asset semantic representation (i.e., Embedding) to determine suitable shot sequences for each script segment.

For example, if the script begins with an unboxing concept, e.g., the unboxing to reveal the product from particular packaging, and there is a corresponding video clip, the scene can align with the video content and script portion.

Video content may have a particular schema defining distinct scenes of the video. For example, an initial portion may be designed to hook the viewer so that they stay on the video vs. scroll to a next video. A second portion may be the body of the product description or review, and a third portion may be a call to action, e.g., a description of how or where to obtain the product. Different video clips or other assets may be tied to each of these portions. For example, the hook portion may be facilitated by a particular matching clip that has a ranking score that satisfies a threshold. The clip can be expressing a particular emotional reaction, e.g., excitement. In some implementations, additional content can be generated to fit a planned schema or script. For example, the avatar library 224 can include avatar emotion assets 228 that represent different emotional responses of the model. Thus, the avatar behavior, look, pose, etc. can vary for different scenes within the video.

The video assembly can also include background images or video. The images can be obtained from a video and image library 238 of the asset repository 222. Thus, images can be selected from a repository of stock images. In some implementations, the images are generated, e.g., using generative AI. The images can be selected by the multi-modality content understanding model 210 based on the input characteristics and classifications. For example, if the product is a brand of coconut water, images or video of tropical beach settings can be used in the background. In another example, if the target audience is located in a particular city, images related to that city can be obtained. In a further example, the time of year or relationship to particular holidays may be used, e.g., for a video generated in December, Christmas images may be included. Different images or videos can be selected for different scenes of the video based, for example, on the script in order to provide a more dynamic video.

Once the structure and organization of the video is complete, the remix video decoration module 816 adds additional details to the video including selecting a voice for the script, and music for the video. In some implementations, performance data of other platform videos can be used in assessing possible decorations of the video. For example, if a particular music style is trending, the music added to the video can be selected based on the trending style.

The remix video decoration module 816 can include a text-to-speech model that generates speech corresponding to the script. Additionally, a particular voice can be selected, e.g., from a voice library 236 of the asset repository 222. For example, voices can be for different languages, different dialects, or different pitches.

Music can be added to complement the video content. The music can be background music or it can be music to complement the script, for example, introductory music before the first speech. The music can be identified based on the input images/video and the script through multimodal matching models. In addition, the music can be selected based on trending music of the platform. The music can be selected from a music library 234 in the asset repository 222.

In some implementations, the remix video decoration module 816 also generates subtitles that can be rendered during the video. The subtitles are based on a segmentation of the script to correspond to the speech components. For example, the segmentation and phrasing of the script can be performed based on natural language processing models including LLM or other generative models.

The clips used from prior videos may already include subtitles corresponding to the original speech used in the prior videos. This may no longer match the generated script. Therefore, the remix video decoration module 816 can also remove pre-existing subtitles.

In some implementations, subtitles are removed by removing a rectangular area around the subtitles in each frame and then filling in the gaps using generative image generation. In other words, the generative image generator is tasked with filling in the removed area based on the context of the surrounding image data and other frames of the video (e.g., without subtitles) in order to recreate the expected image content within the space.

In some other implementations, the process for removing subtitles includes detecting existing subtitles in particular video frames and covering the existing subtitles with the newly generated subtitles, e.g., by matching the location. The background can then be filled with generative fill behind the new subtitle text to cover the old subtitles.

The video is further processed by video speech synching module 218. The video speech synching model 218 aligns the voice components with facial movements of the avatar when visible in the video. Thus, the avatar is presented as speaking the words of the generated script.

The final remix video is then output 220. The video can be presented to the creator user for approval or modification. In some instances, the video generation process described above is carried out multiple times to create a set of video options for the creator user to select from. Once approved, the generated video can be loaded to the content delivery system such that the video is available for selection, e.g., by a content recommendation system, to provide to particular receiving users.

The training of the models used to generate the script, assemble the video, and video decoration can be based on video characteristic data 240. The video characteristic data includes particular data associated with other content that the video should emulate, e.g., other short form video content on the social media platform. In some implementations, the video content is specifically sponsored content videos, but in other implementations, the content can be more broadly encompassing videos on the platform. For example, new trends may originate organically from user supplied content, which can then inform the video generation process to generate videos on trend and representative of native platform content.

The video characteristic data 240 can include video characteristics 242 such as length, language, industry segment, and audience associated, for example with other generated videos along with data on whether users viewed or interacted with the videos.

The video characteristic data 240 can include popular keywords 244. These represent keywords from video content on the social media platform that is popular, meaning the videos with these keywords have signals indicating a positive response by viewers. In some implementations, the keywords relate to other product videos. Signals indicating a positive response can include a viewing time and viewer interactions (e.g., liking the video or commenting on the video).

The video characteristic data 240 can include popular scripts 246. Popular scripts can represent particular text styles or patterns from video content on the social media platform that is popular, meaning particular script content that includes signals indicating a positive response by viewers.

The video characteristic data 240 can include popular voices 248. As described above, the avatar speaks with a particular selected voice. This not only includes male/female but can include age, regional dialect, accents, language, etc. Similar to the above, popular voices relate to voice content in video that includes signals indicating a positive response by viewers of the video content.

The video characteristic data 240 can include popular music 250. Music is often trend dependent. What is popular today may be less popular tomorrow or next month. To keep the content of the generated video having a sense of being current, music, whether by specific artists or just reflecting particular genres or styles, that is currently popular can be preferred. The music can also be based on the target audience, e.g., music popular with the target audience vs. popular generally.

The video characteristic data 240 can include popular looks, stories, and the like 252. As described above, avatars are digital versions of real world models who are digitally captured doing a number of different activities and poses. Some of these may have a more positive response than others by viewers, and in particular by viewers matching the target audience of the video being generated.

The video characteristic data 240 can include popular templates or effects 254. The templates or effects can refer to different transitions between scenes, or different structures to the video storyline. Effects can include, for example, filters (audio and/or video), transitions, augmented reality effects, overlays, or inserted objects. As above, popularity relates to signals indicating a positive viewer response.

The models can be updated periodically based on updated video characteristic data 240. Each generated video is basically a combination of elements (videos, image, voice, music, avatar, script, scenes, industry, audience, etc.), and the performance scores of the videos on the social media platform can be used as labeled cases to continuously train the various models.

Referring back to the potential assets in the avatar library 224, each avatar can include a number of different poses 226, e.g., sitting, standing, etc., emotions 228, presentation styles 230, e.g., storylines, and memes 232.

As described above the avatar looks 226 and avatar emotions 228 refer to different captures of the real life model, for example, seated vs. standing or expressing excitement, delight, or disbelief emotions.

The avatar presentation styles 230 relate to particular avatar storyline. For example, the storyline may be the unboxing of a product. Alternatively, the storyline may relate to the presentation and use of the product. The avatar storylines can include model captures relating to performing different activities that relate to particular activities that can form a storyline for the video. For example, an unboxing storyline may include video clips of the avatar carrying a box, placing the box on a table, opening the box, etc.

The avatar memes 232 relate to trending expressions or gestures that have become popular on the social media system and can be used to enhance the video content. For example, one meme might be a person forming a “heart” symbol with their hands. Other example memes can represent particular scenes, a certain voice/audio style, etc., attached to a certain person and what they said. Other creators perform the meme in their own way on their own generated content such that the viewing audience recognizes the meme being performed. Thus, a variety of new memes can be generated regularly on a given social media platform. The model can be captured performing the meme, which can then be available for inclusion in generated video content.

After a video is output it can be made available to a content delivery system 822. The content delivery system 822 can provide the video to individual user devices associated with the platform. For example, the content delivery system can include a recommendation system that determines content to provide to user devices in response to a request for content. In particular sponsored content items, e.g., advertisements, can be selected for presentation to users by the content delivery system 822, for example, by inserting the sponsored content video into a video feed determined for a particular user.

A remix performance ranker 824 can obtain performance metrics for videos provided by the content delivery system 822. The performance metrics for different video content can be provided to the remix clip generator and ranker 203 for ranking video clips. The performance metrics obtained by the remix performance ranker 824 can include a time to watch (i.e., how long the video is watched by end users), a click through rate (CTR) indicating that users made a selection in the video, e.g., that points of sale for the product, return on ad spend (ROAS), return of interest (ROI), etc.

While metrics can be obtained for the videos as a whole, the content delivery system 822 may track the metrics at a finer level of granularity, e.g., for individual video segments or video components. Segments that can receive performance metrics include the hook of the video (e.g., the first 3-5 seconds), the main body of the video, and the call to action at the end of the video. The components that can receive performance metrics include the creator or avatar being used, the style of the creator or avatar, the music used in the video, the script, particular video clips, images, e.g., background images used in the video, stickers or other decorations, and hashtags.

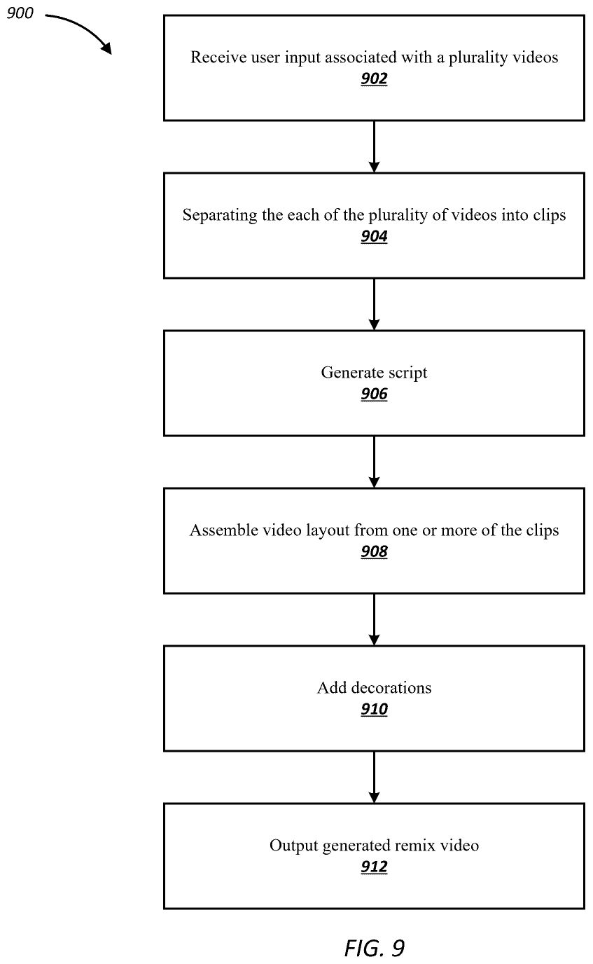

FIG. 9 is a flow diagram of an example process 900 for remix content generation. For convenience, the process 900 will be described as being performed by a system of one or more computers, located in one or more locations, and programmed appropriately in accordance with this specification. For example, a content generation system, e.g., the content generation system 800 of FIG. 8, appropriately programmed, can perform the process 900.

The system receives user input associated with a plurality of videos (902). The user input can be associated with a particular item. The item can be, for example, a product or service. Specifically, the user input can identify two or more previously generated videos associated with the item. One or more of the previously generated videos can be generated according to the content generation system 200 of FIG. 2 or through conventional techniques. The user can also provide images of the item as well as description information about the item. In some implementations, the user further provides details about the content to be provided, for example, a desired length of the generated video, language, target geographic and demographic information, etc.

The system separates each of the plurality of videos into clips (904). The clips can be based, for example, on determining scene breaks in each of the videos and using the scene breaks as clip boundaries. In some implementations, each clip can further undergo processing to determine semantic understanding of the clip, for example, using machine learning models.

The system generates a script (906). The script describes an overall story for the video content being generated. For example, for a particular item, the script indicates not only the words to be used, but also establishes a particular style targeted, for example, toward the specified audience. Furthermore, the script is associated with some individual or partial pieces of media (i.e., video or image) content, e.g., representing the product, which can include one or more selected clips from the clip generator as well as newly acquired or generated assets.

The system assembles a video layout from one or more of the clips (908). In particular, given a particular script, ranking scores of the clips, and a set of assets including an avatar and image content, for example, item images, the system determines an ordered sequence of scenes to compose the overall video.

The system adds one or more decorations (910). For example, the system adds additional details to the video including selecting a voice for the script, and music for the video.

The system outputs one or more generated remix videos (912). In some implementations, the system generates multiple videos and previews them to the user for final selection. After selection, the video can be provided to a content delivery system for providing the video content to users.

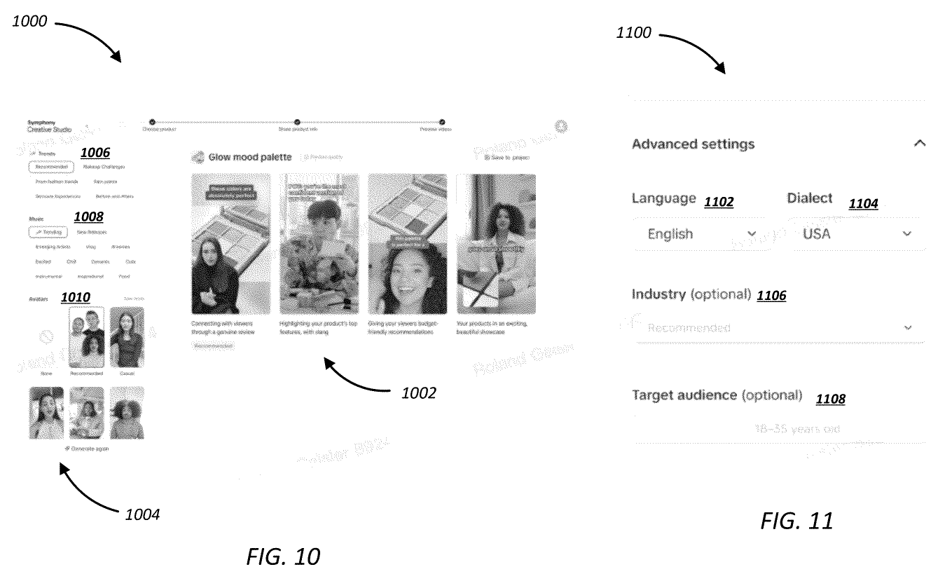

FIG. 10 illustrates an example user interface 1000 in which a number of videos have been generated. The generative process described above is not deterministic, meaning that if it is rerun, the resulting videos will likely be different. In FIG. 10, the right side 1002 indicates previews of four generated videos for the same product (in this example a makeup palette). One is identified as recommended, however, the creator user can select any of the presented videos. On the left side 1004 of the user interface there are some of the user input options, for example, a selection of particular types of trends 1006, music 1008, and avatars 1010. The generated videos are based on the user selections. In some implementations, the user can change one or more of the selections, which causes the videos to be regenerated based on those newly selected parameters.

FIG. 11 shows an example user interface 1100 of additional settings that the creator user can specify to further refine the generated video content. For example, the creator user can specify a language 1102 for the video including a particular dialect 1104 e.g., American English vs. British English. As shown in FIG. 11, the creator user can also select an industry 1106, which can be specific or can be left to the platform to recommend based on the analysis of the product and user supplied content. Finally, FIG. 11 shows a field for the creator user to provide a target audience 1108 for the video, e.g., age ranges, or other demographic information.

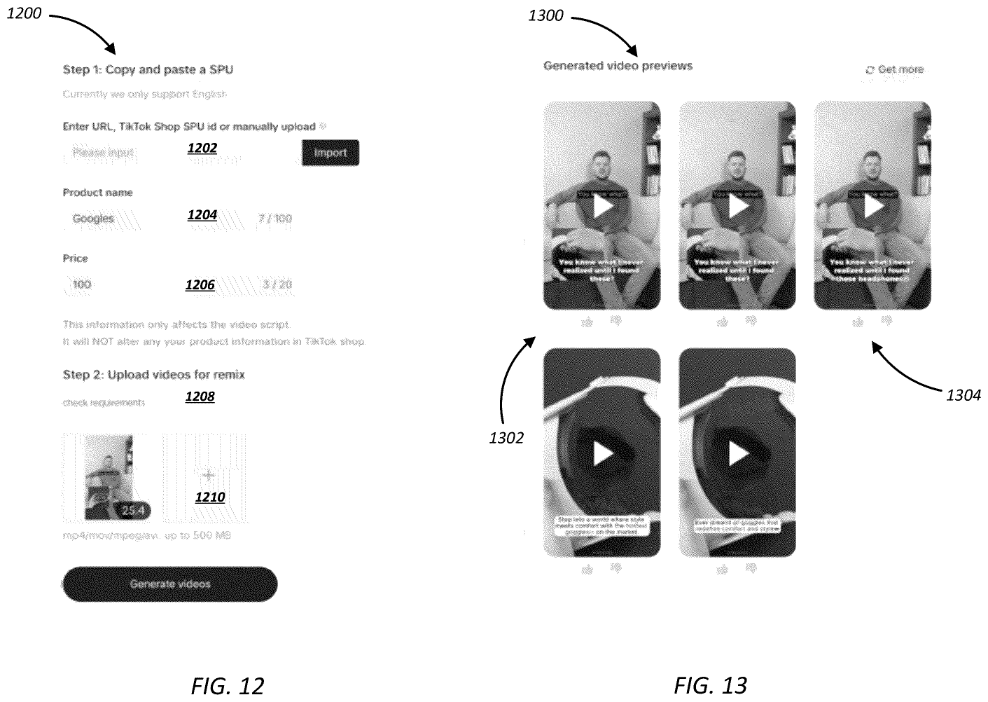

FIG. 12 shows an example user interface 1200 in which a creator user can provide information about the product, e.g., a reference to a product page 1202, a name of the product 1204, and a price 1206. Additionally, the user interface shown in FIG. 12 allows the user to upload videos 1208, e.g., prior videos generated for the product. The user can add additional videos by selecting a “+” element 1210. In some alternative implementations, the user may be able to provide a reference rather than directly uploading. For example, if the video already exists on the platform it may be identified by a video identifier assigned to the video by the platform.

FIG. 13 shows an example user interface 1300 in which the user uploaded videos are previewed. In this example, the user has uploaded five videos 1302. Each video preview is also associated with user controls 1304. The creator user can use the user controls 1304 to indicate a relative approval or disapproval of particular videos e.g., thumbs up or thumbs down, which can indicate the user's style preferences in generating a remixed video based on the uploaded videos.

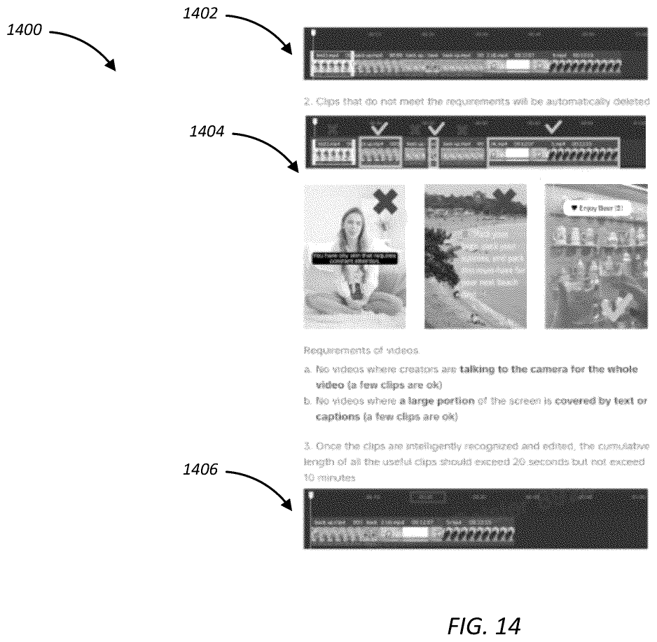

FIG. 14 is a diagram 1400 illustrates some functions of the clip generator. In particular, all uploaded videos are spliced together as a sequence of clips for each video (1402). The clip generator and ranking process may identify some videos, or clips from videos, as not satisfying particular requirements (1404). Clips that do not meet the requirements can be eliminated from use in generating the remixed video. For example, the requirements may include: most video content includes a creator talking to the camera or that most video content does not include large amounts of text or captions covering the images. After this editing, the clips can be reorganized and assembled in an order (1406). The overall length of the video should be greater than 20 seconds but less than 10 minutes. Additionally, if the user has specified a length, the clips are edited to fit within that limit. The video clips can then be decorated and finalized for presentation to the creator user.

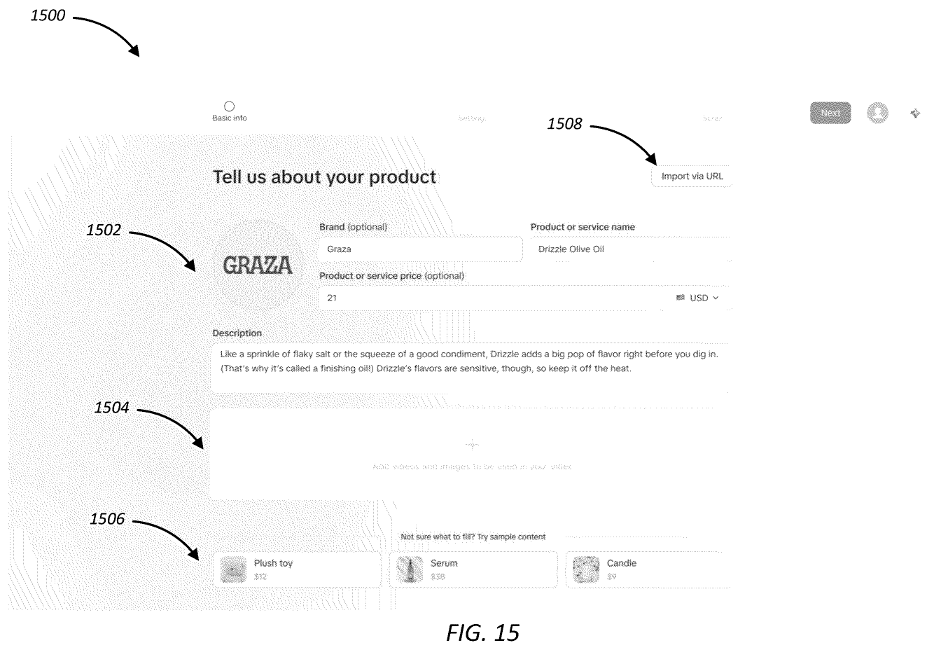

FIGS. 15-20 illustrate example user interfaces for video content generation.

FIG. 15 is an example user interface 1500 for video content generation. For example, the system can provide the user interface 1500 as part of a workflow for generating video content for uploading to the platform. The user interface 1500 of FIG. 15 can represent an initial user interface for generating video content in which a user sets out the initial parameters 1502 of the video content to be generated. For example, when generating a sponsored content item for a particular product, e.g., an advertisement, the user can specify a product name (brand and product type), a sales price, and a description of the product.

The user interface can further include a field 1504 for providing images, video, or other media content associated with the product. For example, the user can drag and drop media content from their device into a region of the user interface. This media content can be used by the system in generating the short-form video content.

In some implementations, the user interface can include prompts of sample products 1506 to provide examples of the types of content that the user can provide and the types of descriptions that can be used.

In some implementations, the user can provide an address, e.g., a uniform resource locator, from which information about the product can be directly imported to the system. For example, a user interface control 1508 can be selected by the user. The user can then input an address corresponding to a commercial site from which the product can be purchased. The system can import information including description, price, and media content from the resources identified by the address.

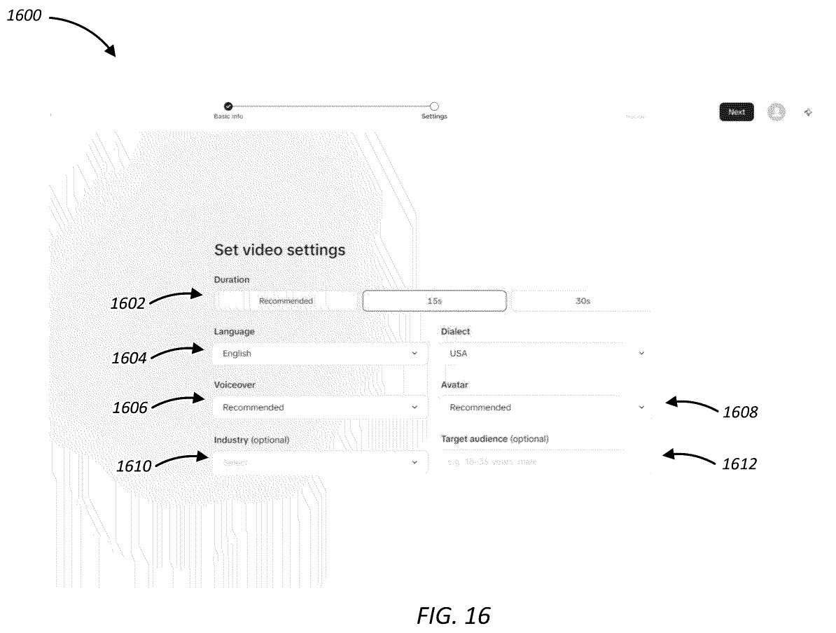

FIG. 16 is another example user interface 1600 for video content generation. For example, FIG. 16 can represent another user interface presented as part of the video generation process, e.g., following the input to the user interface illustrated by FIG. 15. In the user interface 1600 shown in FIG. 16 the user can specify additional parameters including a length of the video to be generated 1602. For example, the user can specify a particular short-form length, e.g., 15 or 30 seconds, or the user can leave this to the recommendation of the system.

Other parameters can include a selected language 1604, including dialect, for voice content of the video, a specification of a voiceover voice and avatar, as well as an industry or target audience of the video. In some implementations, the user can specify a particular voice actor to provide the voiceover and a particular avatar to be used. Alternatively, the user can leave the particular voiceover 1606 and avatar 1608 to the system for recommendation. Avatars and voiceovers are described in more detail below. The industry 1610 can help target the content to a particular field while the audience 1612 allows the user to specify characteristics of the recipients of the content, for example, a particular geographic location, demographics, etc.

Based on the user's input, e.g., as provided to the user interfaces shown in FIG. 15 and FIG. 16, the system generates a script for the video content being generated. The script describes an overall story for the video content being generated. For example, for a particular product, the script indicates not only the words to be used, but also establishes a particular style targeted, for example, toward the specified audience. Furthermore, the script is associated with some individual or partial pieces of media content provided by the user.

As described above, a specifically trained machine learning model can be used to generate the script. For example, the training data for the machine learning model can include a large corpus of content from the platform. In addition to the example content, performance information can also be included in the training data, e.g., indicating how the video content trended generally or with particular audiences. This performance information can be used to augment the script generation. As a result, the system generates a script for the short-form video that has a high likelihood for being on-trend, popular and well targeted to the specified audience the content is relevant to. As an example of how user provided information can be incorporated, particular key terms in the user provided description can be included as input to the machine learning model so that the script incorporates the key terms.

The generated script forms a basis for the voiceover/subtitles of the spoken content in the video. Text to speech techniques can be used to determine the voiceover content.

Based on the user provided input and the generated script, the system examines the user provided media elements. For example, one or more machine learning models can be used to analyze the content of the provided media items to determine semantic information about the media items.

To generate video content, the system does not only rely on the user provided media elements, but can also draw on stock content, e.g., stock video or images, to augment the content used to generate the video. The stock content can be used, for example, as a background to some other foreground content associated with the product of video, for example, a background video or image to present behind a foregoing avatar.

The system assembles the collected content into video scenes. The assembly process automatically analyzes the contents of the user provided elements and the stock media, along with the generated script, to form a semantic representation of the video content. Smart video assembly methods can be executed to find particular combinations of video and/or still image content for each part of the script. For example, the system can automatically find and match the most appealing content to use as the beginning part of the generated video to be used as a hook to attract the targeted audience.

The assembly can also include adjusting the duration of one or more of the provided video media elements to match the constructed storyline and the scenes (e.g., trimming certain parts of the content and video). The outcome of the smart assembly will yield a “video protocol” (e.g., which can be, or be similar in structure to, a JSON file) that comprehensively embodies the video to be generated. This video protocol can be previewed as a rapidly generated video in the user interface for the creating user, for example, in under 5 seconds. The user can modify the video in response to the preview, e.g., using an editing function, as well as ultimately exporting a final video by rendering the video content for use by the platform. In some implementations, the final exporting can occur in a particular time frame, e.g., 50 seconds or greater from the time of execution.

In some implementations, during the video generation time the system obtains additional preferences from the user to reduce the perceived wait time. For example, the user preferences can be obtained in parallel. To the user's perception, this may be based on a user interface provided after completing the parameters of FIG. 16. The additional preferences can include a selection of video elements of what on-screen talent the user would like (digital avatar), what voices, and what music the user prefers. Since our system may not be able to predict these user preferences, the system can seek additional information from the user.

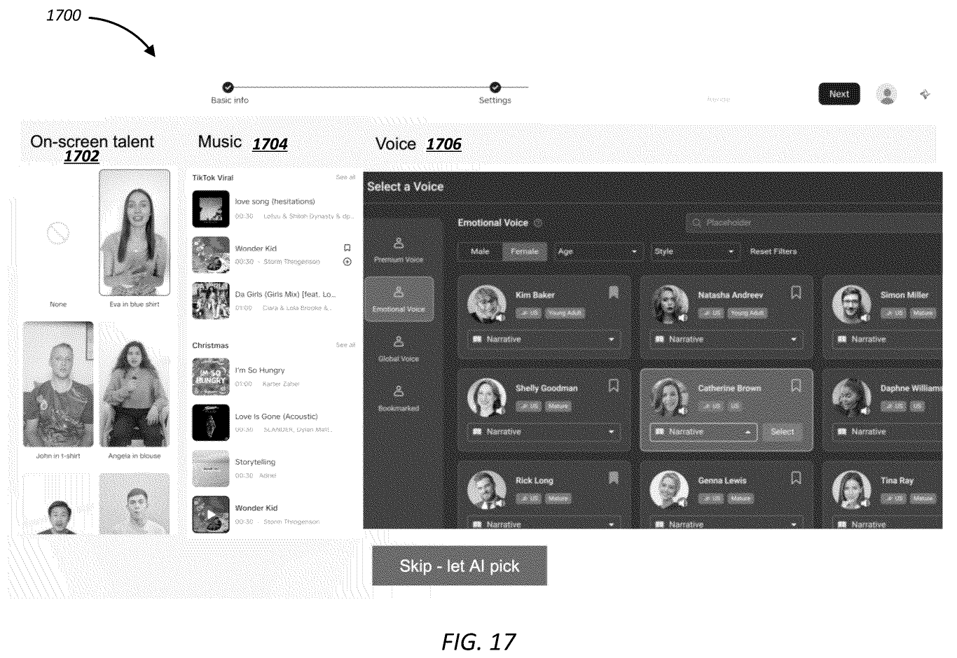

FIG. 17 is an example user interface 1700 for receiving the additional user preferences. In particular, the example user interface includes selection regions for picking an avatar 1702, music 1704, and voice 1706, respectively.

While computer generated avatars exist, the avatars in the present specification correspond to real-life people who have had various image and video captures taken so that they can be animated, including voice synchronization, to be used for customized voice and video content. In addition to the core avatar content, the system can also obtain a collection of emotional reaction videos for the actors sourcing the avatars. For example, the actors can provide a number of different emotional reaction videos as part of the avatar creation process. Example emotional reaction videos can include: The avatar cheers, the avatar points to the bottom of the screen (where the product can be placed), the avatar looks surprised, etc.

Based on the script, the system can insert corresponding emotions into the generated video. For example, if there is a surprise element in the script, the system can detect this and include a surprise emotional piece. The system analyzes the script to identify emotional points and matches the emotional points to corresponding avatar emotional reactions. The avatar can therefore have a range of emotions that can be leveraged to customize the video content to the script.

During the voice synchronization, the system can sync the script to lip movements of the avatar. Moreover, this can be done in multiple languages.

Referring back to FIG. 17, the user can select one or more avatars and/or avatar styles. For example, the same avatar can have different representations, e.g., different clothes or different body posture. The user can also select a preference for particular music to include, which may be based on particular genres or trending music on the platform. The user can also select a voice for use in ‘reading’ the script. Example voiceover options 1706 shown in FIG. 17 include gender, age, and voice style. For example, the user can select one or more avatars and one or more voices to generate video content that is aligned with the target audience.

Based on the above operations, the system generates a final video content for the user. The final video can include a mix and variety of features including one or more avatars, script-driven content, music, and voices the user likes. Information from the model can predict the highest performing mix of avatars, music, and voices for the type of video the user wants to build. For example, if the video corresponds to a sponsored content item for a cream for young women, picking an older male avatar may not be the best choice, or if the target audience is Gen Z, picking country music from the 1950's may also not be best.

Over time, the system will continue to improve the generated video content as performance data for generated videos are used to retrain the machine learning model. A video is basically a combination of elements (videos, image, voice, music, avatar, script, scenes, industry, audience, etc.), and the performance scores of the videos by the platform can be used as labeled test cases to continuously train the machine learning model. After the video output, the system can provide an editing user interface in which the user can make particular changes to the video, especially the generated elements like the scripts, on-screen talent (avatars, voiceover), etc. The platform records the edit actions which will give feedback to the generation algorithm to learn from the further edits for more accurate generation in the future.

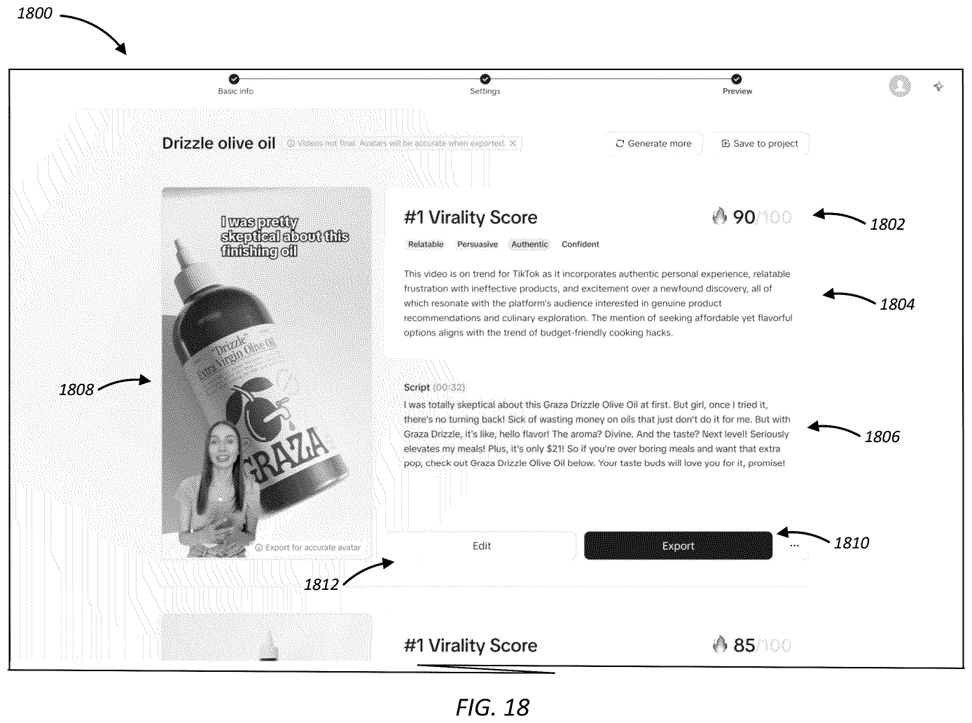

FIG. 18 shows an example user interface 1800 illustrating an output presentation of generated videos. The output may not be a single video, but may be a collection of videos each assigned a respective score 1802, referred to as a virality score, as shown in FIG. 18. The score is calculated based on a number of signals and tries to predict how viral or successful the video will be on the platform. Some of the key signals that are inputs to this score are based on a machine learning model that is trained on sponsored content of the platform, and that can determine how similar the produced videos are to the ones that exist on the platform-. Various approaches can be used to compare the video content including, for example, a diffusion model. When evaluating similarity with the machine learning model, the system assess one or more of following dimensions: length of video, voice type, avatar type, emotional b-roll content used, type of assets (images, videos), content of assets (what is in the video, image), music type and song, industry for the sponsored content item, audience for the sponsored content item (age group, location, segment, etc.), script length, script content, structure of video (hook, main part, call to action), performance of the sponsored content item, virality of content (# of clicks, # of comments from people, # of people commented positively vs negative), hashtags used, etc.

Referring back to FIG. 18, the user is presented with an analysis of the video 1804 describing the reason for the given score, the video script 1806, and a representative screenshot 1808 taken from the generated video. The user can choose to finalize one of the videos (export button) 1810, or to edit the particular video option (edit button) 1812.

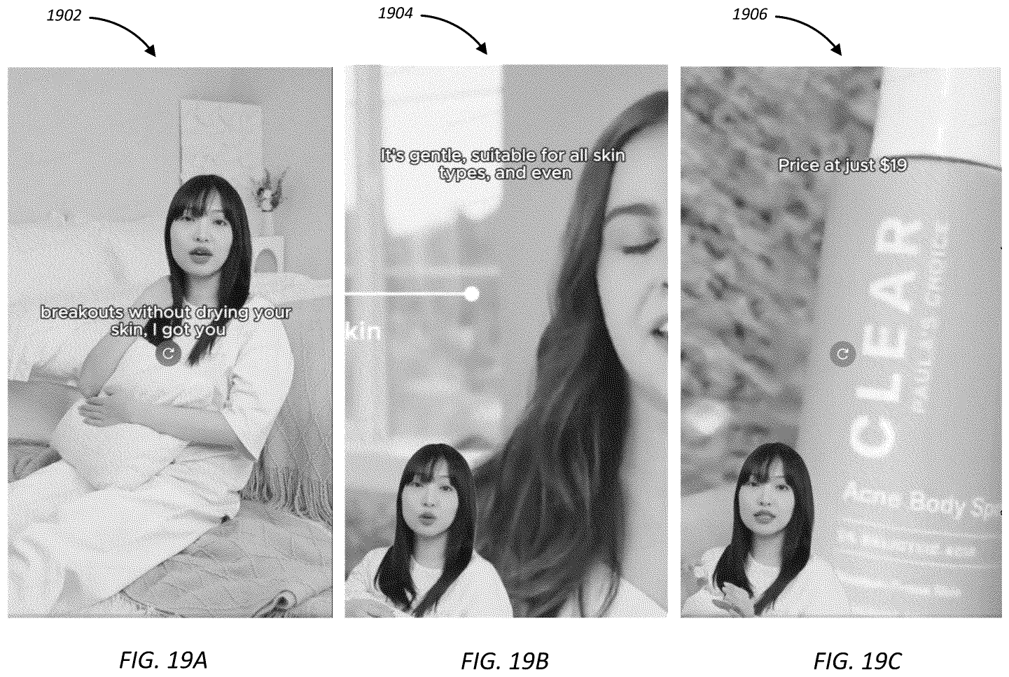

FIGS. 19A-C show three separate example representations 1902, 1904, and 1906 of portions of an output video generated by the system. In particular, the respective images show an example output video with the avatar dressed in yellow and the background corresponding to different input images and videos. The last image can represent a closing shot of the video showcasing the product. The text or caption in the video images shows how the script translates to the video. Although not illustrated in the figures, the video content is played (optionally to music), where the avatar is seen as speaking to match the script.

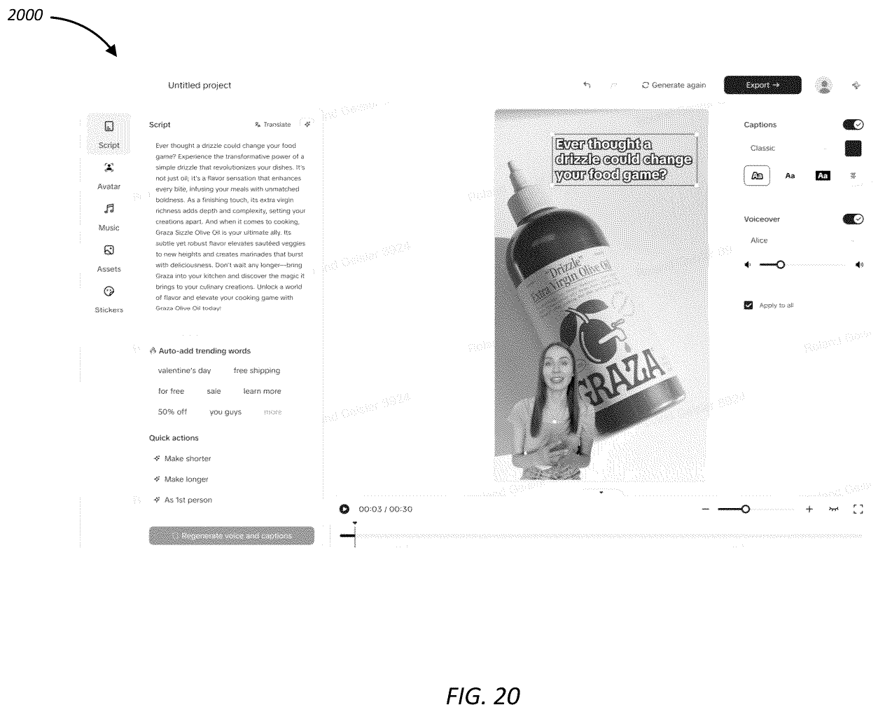

FIG. 20 shows an example user interface 2000 for editing a generated video. Using the editing interface, the user can modify various aspects of the generated video including the script, the avatar, the music, the voice, media elements incorporated into the video, or captions, stickers, or other additional overlays to the video content (e.g., captions of text presented over the video during playback). In modifying the script, the user can adjust the language used based on their preferences or to incorporate additional trending keywords to attempt to improve performance.

In some implementations, one or more scenes of a generated video or a generated remix video are automatically generated. For example, the generated video can be a mix of user supplied assets and generated assets including video and image assets. Generating a video can be based on a scene to be created, which in turn is based on a part of the generated script. Thus, the generated script can include a scene for which the user has not supplied assets or that there are not matching stock assets. Generative AI can be used to create the scene content based on, for example, other assets of the video and the generated script.

As described above, the techniques described in this specification can be used to generate video content, and in particular short-form video content. The video generation system can be part of an online social media or other content sharing platform. The video content can be generated as a sponsored content item that can be provided to users of the platform, e.g., as advertising content that is selected by the platform to provide to users according to particular selection criteria. The sponsored content can be included within a stream of other individual short-form videos provided to a user device. An example of such a platform used to present video content to users of the platform is described below.

In some implementations, the provides video content to users of the platform, for example, as part of a feed of videos presented in a user interface of a user device. The videos can be provided to the social media platform by other users (e.g., creators).

For example, a creator user associated with a particular user device can provide a video to the platform. Video content can also be delivered to user devices by the platform. The user devices can be any Internet-connected computing device, e.g., a laptop or desktop computer, a smartphone, or an electronic tablet. The user device can be connected to the Internet through a mobile network, through an Internet service provider (ISP), or otherwise.

Each user device is configured with software, which will be referred to as a client or as client software, that in operation can access the platform so that a user can interact with the platform. For example, the creating user can use the client software to upload video content to the platform as well as receive videos from the platform. The client software can be a platform specific application installed on the user device.

In some implementations, the client software provides a user interface for interacting with the platform. The user interface can include receiving data from the platform for presenting a feed of videos that the user can interact with. For example, the user can scroll up or down to switch between videos in the feed as well as interact with individual videos, e.g., by posting comments about the video, sharing the video, or expressing approval, e.g., liking the video.

In some further implementations, the client software provides user interfaces for generating video content as described above.

In some implementations, the video content provided by the platform to user devices are short-form videos. Short-form videos are videos that are typically less than 90 seconds in length. In some implementations, short-form videos have lengths of between 15 and 90 seconds. By contrast, long-form videos typically have lengths of at least 3 minutes.

In one example, a user device obtains or creates a video. The user device can be a mobile device that generates the video using a camera of the mobile device. The user of the user device can use the client software to upload the video to the platform, for example, to make the video content available for distribution to other users of the platform.

The platform processes videos received from the user device or otherwise obtained. The video processing can include various operations including encoding, transcoding, and labeling (e.g., categorizing) the video. The video content is then stored in video storage for potential delivery to user devices. For example, the platform can add the video (or an identifier of the video) to a candidate pool of videos. The video storage may be a distributed storage among multiple storage devices. Further, the video storage may be replicated in multiple locations such that multiple copies of the versions are stored, e.g., in multiple datacenters.

In response to a triggering event, the platform determines one or more items to provide to a user. The triggering event can be, for example, a user execution of software on a user device that initiates a session with the platform. For example, a user opening an application associated with the platform on a user device can be the trigger event for providing a set of items to the user. The trigger event can also be a response to user interaction. For example, a user interface can be presented to the user, e.g., in the user application executing on the user device, that includes a feed of content items. A user having scrolled through a specified amount of content items in the feed can be a trigger to fetch a new set of items to deliver to the user device.

To determine the one or more items to provide to the user, the platform can employ a recommendation system that recommends one or more items to the user from a large collection of candidate items. The recommendation system can be, for example, a machine learning model that predicts items likely to be of interest to the user based, for example, on historical activities of the user as well as the trained model parameters.

The historical activities of the user can include user interactions with content items presented in the user interface on the user device. The interactions can be specific indications of interest, for example, by directly liking the content item. In some implementations, other types of interactions can be used as signals that, when taken in combination, can provide an overall judgment of interests or disinterest in the content items by the user. For example, a duration spent viewing the video can be a signal that can be used to infer interest or disinterest.

In some implementations, the recommendation system can select one or more sponsored content items to include in the video feed provided to a particular user. The recommendation system can identify sponsored content items likely to be of interest to the user. In some other implementations, a separate recommendation system directed to identifying sponsored content to provide to users performs the selection of one or more sponsored content items that are then inserted into the set of videos being provided to the user.

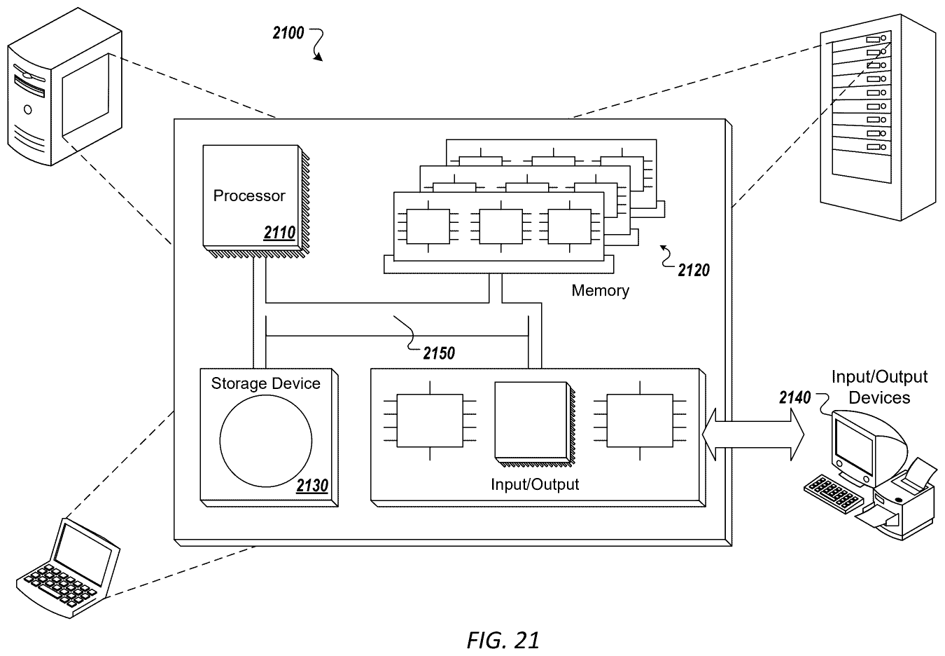

FIG. 21 is a block diagram of a schematic diagram of an example computing system 2100. The system 2100 can be used for the operations described in association with the implementations described herein. For example, the system 2100 may be included in any or all of the components of the content delivery system or video processing systems discussed in this specification. The system 2100 includes a processor 2110, a memory 2120, a storage device 2130, and an input/output device 2140. The components 2110, 2120, 2130, and 2140 are interconnected using a system bus 2150. The processor 2110 is capable of processing instructions for execution within the system 2100. In some implementations, the processor 2110 is a single-threaded processor. The processor 2110 is a multi-threaded processor. The processor 2110 is capable of processing instructions stored in the memory 2120 or on the storage device 2130 to display graphical information for a user interface on the input/output device 2140.

The memory 2120 stores information within the system 2100. In some implementations, the memory 2120 is a computer-readable medium. The memory 2120 can be a volatile memory unit or a non-volatile memory unit. The storage device 2130 is capable of providing mass storage for the system 2100. The storage device 2130 is a computer-readable medium. The storage device 2130 may be a floppy disk device, a hard disk device, an optical disk device, or a tape device. The input/output device 2140 provides input/output operations for the system 2100. The input/output device 2140 includes a keyboard and/or pointing device. The input/output device 2140 includes a display unit for displaying graphical user interfaces.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices.

To provide for interaction with a user, the subject matter described in this specification can be implemented on one or more computers having, or configured to communicate with, a display device, e.g., an LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

In addition to the embodiments of the attached claims and the embodiments described above, the following numbered embodiments are also innovative:
Embodiment 1 is a method for generating a video, the method comprising: receiving one or more user input identifying information associated with one or more media elements and one or more characteristics of the video to be generated; and generating video content based on the received one or more user inputs, the generating comprising: identifying assets to include in the video, the assets including an avatar, generating a script for the video, and assembling a video layout.
Embodiment 2 is the method of embodiment 1, wherein identifying assets includes using a multi-modal machine learning model to select an avatar and image assets that satisfy a threshold probability of being of interest to a target audience based on an understanding of a subject of the video.
Embodiment 3 is the method of any one of embodiments 1-2, wherein generating the script comprises using a large language model trained on short form video content of a social media platform such that the script matches a style and tone of video content on the social media platform.
Embodiment 4 is the method of any one of embodiments 1-3, wherein assembling the video layout comprises defining a sequence of scenes, each scene having a particular avatar look and segment of the generated script.
Embodiment 5 is the method of any one of embodiments 1-4, the generating further comprising adding one or more video decorations, wherein adding video decorations comprise adding particular voice content to give voice to the script and/or identifying music to include in the video.
Embodiment 6 is the method of any one of embodiments 1-5, wherein receiving one or more user inputs comprises receiving a user specification of a reference to a location containing information about a subject product.
Embodiment 7 is a method for generating a video, the method comprising: receiving one or more user inputs identifying information associated with one or more media elements and one or more characteristics, the one or more media elements including one or more videos; and generating a remixed video content based on the received one or more user inputs, wherein generating the remixed video content comprises: separating the one or more videos into respective clips; generating a script; and assembling a video layout from one or more of the clips.
Embodiment 8 is the method of embodiment 7, wherein separating the one or more videos into respective clips further comprises assigning a ranking score to each clip based on a plurality of ranking criteria.
Embodiment 9 is the method of any one of embodiments 7-8, wherein generating the script comprises using a large language model trained on short form video content of a social media platform such that the script matches a style and tone of video content on the social media platform.

Embodiment 10 is the method of any one of embodiments 7-9, wherein assembling the video layout comprises defining a sequence of scenes using the one or more clips and segments of the script.
Embodiment 11 is the method of any one of embodiments 7-10, wherein assembling the video layout comprises generating video content to include with the one or more clips including one or more of adding images or automatically generated scenes using an avatar.
Embodiment 12 is the method of any one of embodiments 7-11, further comprising adding video decorations to the assembled video layout, wherein adding video decorations comprises adding particular voice content to give voice to the script and/or identifying music to include in the video.
Embodiment 13 is the method of any one of embodiments 7-12, further comprising adding video decorations to the assembled video layout, wherein adding video decorations comprises removing pre-existing subtitles from the one or more clips.
Embodiment 14 is the method of any one of embodiments 7-13, wherein receiving one or more user inputs identifying information associated with one or more media elements comprises receiving one or more previously created short-form videos associated with the user.
Embodiment 15 is a system comprising: one or more computers and one or more storage devices storing instructions that are operable, when executed by the one or more computers, to cause the one or more computers to perform the method of any one of embodiments 1 to 6.
Embodiment 16 is a computer storage medium encoded with a computer program, the program comprising instructions that are operable, when executed by data processing apparatus, to cause the data processing apparatus to perform the method of any one of embodiments 1 to 6.
Embodiment 17 is a system comprising: one or more computers and one or more storage devices storing instructions that are operable, when executed by the one or more computers, to cause the one or more computers to perform the method of any one of embodiments 7 to 14.
Embodiment 18 is a computer storage medium encoded with a computer program, the program comprising instructions that are operable, when executed by data processing apparatus, to cause the data processing apparatus to perform the method of any one of embodiments 7 to 14.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for generating a video comprising:
receiving one or more user input identifying information associated with one or more media elements and one or more characteristics of the video to be generated; and
generating video content based on the received one or more user inputs, the generating comprising:
identifying assets to include in the video, the assets including an avatar,
generating a script for the video, and
assembling a video layout.

2. The method of claim 1, wherein identifying assets includes using a multi-modal machine learning model to select an avatar and image assets that satisfy a threshold probability of being of interest to a target audience based on an understanding of a subject of the video.

3. The method of claim 1, wherein generating the script comprises using a large language model trained on short form video content of a social media platform such that the script matches a style and tone of video content on the social media platform.

4. The method of claim 1, wherein assembling the video layout comprises defining a sequence of scenes, each scene having a particular avatar look and segment of the generated script.

5. The method of claim 1, the generating further comprising adding one or more video decorations, wherein adding video decorations comprise adding particular voice content to give voice to the script and/or identifying music to include in the video.

6. The method of claim 1, wherein receiving one or more user inputs comprises receiving a user specification of a reference to a location containing information about a subject product.

7. A method for generating a video comprising:
receiving one or more user inputs identifying information associated with one or more media elements and one or more characteristics, the one or more media elements including one or more videos; and
generating a remixed video content based on the received one or more user inputs, wherein generating the remixed video content comprises:
separating the one or more videos into respective clips;
generating a script; and
assembling a video layout from one or more of the clips.

8. The method of claim 7, wherein separating the one or more videos into respective clips further comprises assigning a ranking score to each clip based on a plurality of ranking criteria.

9. The method of claim 7, wherein generating the script comprises using a large language model trained on short form video content of a social media platform such that the script matches a style and tone of video content on the social media platform.

10. The method of claim 7, wherein assembling the video layout comprises defining a sequence of scenes using the one or more clips and segments of the script.

11. The method of claim 7, wherein assembling the video layout comprises generating video content to include with the one or more clips including one or more of adding images or automatically generated scenes using an avatar.

12. The method of claim 7, further comprising adding video decorations to the assembled video layout, wherein adding video decorations comprises adding particular voice content to give voice to the script and/or identifying music to include in the video.

13. The method of claim 7, further comprising adding video decorations to the assembled video layout, wherein adding video decorations comprises removing pre-existing subtitles from the one or more clips.

14. The method of claim 7, wherein receiving one or more user inputs identifying information associated with one or more media elements comprises receiving one or more previously created short-form videos associated with the user.

15. A system comprising:
one or more computers and one or more storage devices on which are stored instructions that are operable, when executed by the one or more computers, to cause the one or more computers to perform operations comprising:
receiving one or more user input identifying information associated with one or more media elements and one or more characteristics of the video to be generated; and
generating video content based on the received one or more user inputs, the generating comprising:
identifying assets to include in the video, the assets including an avatar,
generating a script for the video, and
assembling a video layout.

16. The system of claim 15, wherein identifying assets includes using a multi-modal machine learning model to select an avatar and image assets that satisfy a threshold probability of being of interest to a target audience based on an understanding of a subject of the video.

17. The system of claim 15, wherein generating the script comprises using a large language model trained on short form video content of a social media platform such that the script matches a style and tone of video content on the social media platform.

18. The system of claim 15, wherein assembling the video layout comprises defining a sequence of scenes, each scene having a particular avatar look and segment of the generated script.

19. The system of claim 15, the generating further comprising adding one or more video decorations, wherein adding video decorations comprise adding particular voice content to give voice to the script and/or identifying music to include in the video.

20. The system of claim 15, wherein receiving one or more user inputs comprises receiving a user specification of a reference to a location containing information about a subject product.
